(19) United States
(12) Patent Application Publication
(10) Pub. No.: US 2004/0071889 A1
(43) Pub. Date: Apr. 15, 2004

(54) Method of producing an antireflection-coated substrate

(75) Inventors: Tsutomu Asakawa, Tokyo (JP); Kenji Matsumoto, Tokyo (JP); Koshi Harada, Tokyo (JP); Kyoji Nakayama, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 10/634,886

(22) Filed: Aug. 6, 2003

(30) Foreign Application Priority Data
Aug. 7, 2002 (JP) 229473/2002

(51) Int. Cl. B05D 5/06; B05D 1/36

(52) U.S. Cl. 427/402; 427/162

(57) ABSTRACT

On producing an antireflection-coated substrate which includes a transparent substrate (1) and an antireflection film formed on the transparent substrate, the antireflection film is made of a multilayer film having a medium refractive index layer (2), a high refractive index layer (3), and a low refractive index layer (4) successively formed on the transparent substrate in this order. The medium refractive index layer is made of a material containing silicon, tin, and oxygen. The high refractive index layer is made of a material containing oxygen and at least one element selected from a group consisting of titanium, niobium, tantalum, and hafnium. The low refractive index layer is made of a material containing silicon and oxygen. The antireflection film is formed by successively depositing these layers by an in-line sputtering apparatus.

This invention claims priority to prior Japanese patent application JP 2002-229473, the disclosure of which is incorporated herein by reference.

### BACKGROUND OF THE INVENTION

This invention relates to a method of producing an antireflection-coated substrate for use as a dust-proof substrate for a liquid crystal panel (in particular, a liquid crystal projector of a projection type), a cover glass for a solid-state image pickup device to serve as a package window of a solid-state image pickup device in an image sensor, such as a CCD (Charge Coupled Device) sensor and a CMOS (Complementary Metal Oxide Semiconductor) sensor, a substrate for a measuring instrument, or the like.

As illustrated in FIG. 1, a liquid crystal projector of a projection type comprises a liquid crystal apparatus 100. A light beam emitted from a light source (not shown) is condensed by a condensing optical system (not shown) and guided to the liquid crystal apparatus 100. The light beam is optically modulated by a liquid crystal layer 50 and then projected to a screen via an optical system (not shown), such as a lens, so that a predetermined image is displayed on the screen. The light beam from the light source is condensed so that a focal point is positioned in the liquid crystal layer 50 of the liquid crystal apparatus 100. It is assumed here that a flaw or a dust particle 201 is attached to an outer surface of an opposite substrate 20. In this event, the flaw or the dust particle 201 is located at a distance of about 1 mm, which corresponds to the thickness of a substrate 21 of the opposite substrate 20, from the liquid crystal layer 50 as a focal position. Thus, the flaw or the dust particle 201 is present within a range of a focal distance and is put in a focused condition. Similarly, it is assumed that a flaw or a dust particle 202 is attached to an outer surface of a drive substrate 30. In this event, the flaw or the dust particle 202 is located at a distance of about 1 mm, which corresponds to the thickness of a substrate 31 of the drive substrate 30, from the liquid crystal layer 50. Thus, the flaw or the dust particle 202 is present within the range of the focal distance and is put in a focused condition. As a result, in case where the display is carried out by the use of the liquid crystal projector of a projection type comprising a liquid crystal cell with the flaw or the dust particle 201 or 202 attached to the outer surface, the flaw or the dust particle 201 or 202 appears in a projected image and the display quality is degraded. In order to avoid the above-mentioned problem, a pair of transparent substrates 41a and 41b, each of which has a thickness of about 1 mm and is made of, for example, a glass, are disposed adjacent to the liquid crystal cell so that the liquid crystal cell is interposed therebetween. The transparent substrates 41a and 41b serve as dust-proof substrates 40a and 40b to protect the outer surfaces of the substrates 20 and 30 of the liquid crystal cell from a flaw or a dust particle, respectively. Even if a flaw or a dust particle 211 or 212 is attached to an outer surface of the dust-proof substrate 40a or 40b which is not adjacent to the liquid crystal cell, the flaw or the dust particle 211 or 212 is put in a defocused condition due to the thickness of the dust-proof substrate 211 or 212. Thus, the display quality is not degraded.

Generally, the dust-proof substrate mentioned above is obtained by depositing an antireflection film comprising an Al₂O₃/ZrO₂/MgF₂ multilayer film on one surface of a transparent substrate by vapor deposition. Proposal is also made of an antireflection film comprising a plurality of SiO₂ layers and ZrO₂ layers alternately laminated (JP 2000-282134 A).

In the meanwhile, a CCD or a CMOS is housed in a sealed chip package for the purpose of power supply to a chip, signal distribution, heat release, and circuit protection. A cover glass for the chip package is disclosed, for example, in JP H7-172868 A. In the cover glass disclosed therein, an antireflection film is formed on a surface of a glass substrate in order to efficiently introduce a light beam to the CCD or the CMOS. The antireflection film comprises a multilayer film having two or three layers deposited by the use of two or three kinds of materials selected from a group consisting of aluminum oxide, yttrium oxide, tantalum oxide, silicon oxide, magnesium fluoride, and strontium fluoride. For example, the antireflection film has a film structure of Al₂O₃/Ta₂O₅/MgF₂ or Al₂O₃/ZrO₂/MgF₂.

The multilayer film is generally formed by vapor deposition, like the above-mentioned antireflection film of the dust-proof substrate.

In case where the antireflection film comprising the multilayer film, such as Al₂O₃/ZrO₂/MgF₂, is formed by vapor deposition, foreign matters, splash, or pinholes will be caused to occur by the vapor deposition. Presence of the foreign matters or the splash causes scattering of light while the presence of the pinholes causes reflection of light. As a result, it is impossible to achieve the optical characteristic required for the dust-proof substrate (i.e., the reflectance of 0.5% or less (the single-surface reflectance on one surface on the side of the antireflection film)) and the optical characteristic required for the cover glass for a solid-stage image pickup device (i.e., the reflectance of 1% or less (the double-surface reflectance by the antireflection film and the glass substrate). Particularly, the dust-proof substrate is exposed to a severe environment of an extremely high temperature for a long time so that film peeling is caused at an interface between the respective layers. In view of the above, it is proposed to form the Al₂O₃/ZrO₂/MgF₂ multilayer film by reactive sputtering. However, it is extremely difficult to stably deposit MgF₂ as fluoride. Thus, stable optical characteristics can not be obtained and a heavy load is imposed upon production.

In case of the antireflection film comprising a plurality of SiO₂ layers and ZrO₂ layers alternately laminated, at least four layers are required and the film thickness must strictly be controlled for each layer. Thus, stable optical characteristics can not be obtained and a heavy load is imposed upon production.

### SUMMARY OF THE INVENTION

It is therefore an object of this invention to provide a method of producing an antireflection-coated substrate which is excellent in film adhesion without causing film peeling even under a severe environment.

It is another object of this invention to provide a method of producing an antireflection-coated substrate which is for use as a dust-proof substrate for a liquid crystal panel and a cover glass for a solid-state image pickup device and which satisfies a desired optical characteristic required for each of the dust-proof substrate and the cover glass.

In order to achieve the above-mentioned objects, this invention has following structures.

Structure 1

A method of producing an antireflection-coated substrate comprising a transparent substrate and an antireflection film formed on the transparent substrate, the antireflection film comprising a multilayer film having a medium refractive index layer, a high refractive index layer, and a low refractive index layer successively formed on the transparent substrate in this order, the medium refractive index layer being made of a material containing silicon, tin, and oxygen, the high refractive index layer being made of a material containing oxygen and at least one element selected from a group consisting of titanium, niobium, tantalum, and hafnium, the low refractive index layer being made of a material containing, silicon and oxygen, the antireflection film being formed by successively depositing these layers by an in-line sputtering apparatus.

Structure 2

A method according to structure 1, wherein the antireflection film is formed by sputtering or reactive sputtering in an inactive gas atmosphere or in a mixed gas atmosphere containing an inactive gas and an oxygen gas, the medium refractive index layer being deposited by the use of target made of a material containing silicon and tin, the high refractive index layer being deposited by the use of a target made of a material containing one element selected from a group consisting of titanium, niobium, tantalum, and hafnium, the low refractive index layer being deposited by the use of a target made of a material containing silicon.

Structure 3

A method according to structure 2, wherein each of the medium refractive index layer, the high refractive index layer, and the low refractive index layer is deposited by the use of a plurality of targets.

Structure 4

A method according to any one of structures 1 through 3, wherein the medium refractive index layer has a refractive index between 1.6 and 1.8 and a geometrical thickness between 60 nm and 90 nm, the high refractive index layer having a refractive index between 2.1 and 2.8 and a geometrical thickness between 90 nm and 130 nm, the low refractive index layer having a refractive index between 1.4 and 1.46 and a geometrical thickness between 80 nm and 100 nm.

Structure 5

A method according to structure 4, wherein the medium refractive index layer comprises SiₓSn_{y}O_{z}, the high refractive index layer comprising a material selected from a group consisting of TiO₂, Nb₂O₅, Ta₂O₅, and HfO₂, the low refractive index layer comprising SiO₂.

Structure 6

A method according to any one of structures 1 through 5, wherein the transparent substrate is a glass substrate having a refractive index between 1.46 and 1.53.

Structure 7

A method according to structure 6, wherein an antireflection-coated surface of the glass substrate on which the antireflection film is formed has a surface roughness of 0.5 nm or less as a center-line-mean roughness Ra.

Structure 8

A method according to any one of structures 1 through 7, wherein a transparent conductive film is formed between the high refractive index layer and the low refractive index layer.

Structure 9

A method according to any one of structures 1 through 8, wherein the antireflection-coated substrate is a dust-proof substrate for a liquid crystal panel.

Structure 10

A method according to structure 9, wherein the liquid crystal panel is a liquid crystal panel for a liquid crystal projector of a projection type.

Structure 11

A method according to any one of structures 1 through 7, wherein the antireflection-coated substrate is a cover glass for a solid-state image pickup device.

### BRIEF DESCRIPTION OF THE DRAWINGS

FIG. 1 is a schematic view for describing a function of a dust-proof substrate;

FIG. 2 is a schematic view for describing a dust-proof substrate for a liquid crystal panel, which is produced by a method according to this invention;

FIG. 3 is a schematic view for describing an in-line sputtering apparatus for producing an antireflection-coated substrate according to this invention;

FIG. 4 is a schematic view showing a liquid crystal panel with the dust-proof substrate in FIG. 2;

FIG. 5 is a view for describing a cover glass for a solid-state image pickup device, which is produced by the method according to this invention; and

FIG. 6 is a view for describing a solid-state image pickup device with the cover glass in FIG. 5.

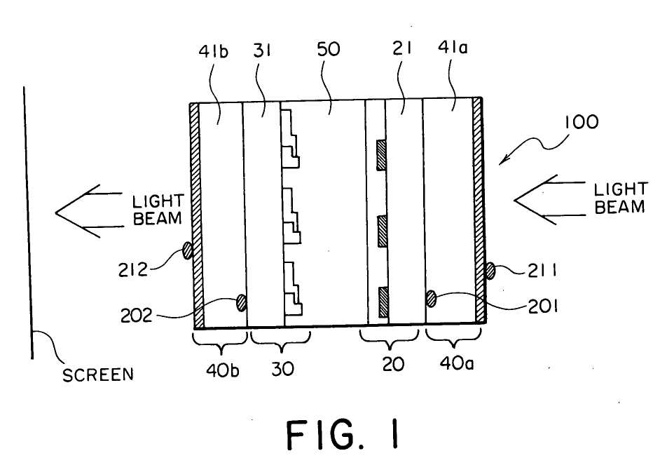

### DESCRIPTION OF THE PREFERRED EMBODIMENTS

According to this invention, a method of producing an antireflection-coated substrate comprises the step of successively depositing, on a transparent substrate, a medium refractive index layer made of a material containing silicon, tin, and oxygen, a high refractive index layer made of a material containing oxygen and at least one element selected from a group consisting of titanium, niobium, tantalum, and hafnium, and a low refractive index layer made of a material containing silicon and oxygen in this order by the use of an in-line sputtering apparatus to form a multilayer film as an antireflection film. (Structure 1)

As a sputtering method, a method using an opposed target static deposition sputtering apparatus or a method using an in-line sputtering apparatus is available. In case where deposition is successively carried out using the in-line sputtering apparatus, an unnecessary oxide film is not formed between respective layers of the antireflection film and a film interface or boundary is not substantially formed at each layer. Therefore, the antireflection-coated substrate is excellent in film adhesion without causing film peeling. In view of the productivity also, the method using the in-line sputtering apparatus is advantageous. In the sputtering method, occurrence of defects, such as foreign matters, splash, and pinholes is suppressed.

The above-mentioned antireflection film is formed by sputtering or reactive sputtering in an inactive gas atmosphere or in a mixed gas atmosphere containing an inactive gas and an oxygen gas. The medium refractive index layer is deposited by the use of target made of a material containing silicon and tin. The high refractive index layer is deposited by the use of a target made of a material containing one element selected from a group consisting of titanium, niobium, tantalum, and hafnium. The low refractive index layer is deposited by the use of a target made of a material containing silicon. (Structure 2)

An oxide film containing silicon, tin, and oxygen and serving as the medium refractive index layer has a high transmittance and an excellent chemical resistance (corrosion resistance, alkali resistance). In addition, it is possible to prevent oxygen loss of the material (TiO₂) containing titanium and oxygen, the material (Nb₂O₅) containing niobium and oxygen, the material (Ta₂O₅) containing tantalum and oxygen, and the material (HfO₂) containing hafnium and oxygen, which are deposited on the oxide film. Therefore, the high refractive index layer formed on the oxide film as the medium refractive index layer has a high transmittance and is transparent in a visible range.

The oxide film containing silicon, tin, and oxygen may be formed by sputtering in an inactive gas atmosphere or in a mixed gas atmosphere containing an inactive gas and an oxygen gas by the use a target containing silicon, tin, and oxygen or by reactive sputtering in a mixed gas atmosphere containing an inactive gas and an oxygen gas by the use of a target containing silicon and tin. Preferably, the oxide film containing silicon, tin, and oxygen is formed by reactive sputtering in a mixed gas atmosphere containing an inactive gas and an oxygen gas by the use of a target containing silicon and tin.

The oxide film containing oxygen and one element selected from a group consisting of titanium, niobium, tantalum, and hafnium is a titanium oxide film made of a material containing titanium and oxygen, a niobium oxide film made of a material containing niobium and oxygen, a tantalum oxide film made of a material containing tantalum and oxygen, or a hafnium oxide film made of a material containing hafnium and oxygen. These films may be formed by sputtering or reactive sputtering in an inactive gas atmosphere or in a mixed gas atmosphere containing an inactive gas and an oxygen gas by the use of a target made of a titanium-containing material (for example, TiO₂ or TiO₂₋ₓ or Ti), a target made of a niobium-containing material (for example, Nb₂O₅ or Nb₂O₅₋ₓ or Nb), a target made of a tantalum-containing material (for example, Ta), and a target made of a hafnium-containing material (for example, HfO₂ or HfO₂₋ₓ or Hf), respectively.

The film made of a material containing titanium and oxygen and the film made of a material containing niobium and oxygen are preferably formed by sputtering in an inactive gas atmosphere or in a mixed gas atmosphere containing an inactive gas and an oxygen gas by the use of a target made of a material containing TiO₂ or TiO₂₋ₓ and a target made of a material containing Nb₂O₅ or Nb₂O₅₋ₓ, respectively. This is because shortage of oxygen contained in the titanium oxide film and the niobium oxide film is prevented.

The film made of a material containing tantalum and oxygen and the film made of a material containing hafnium and oxygen are preferably formed by sputtering in a mixed gas atmosphere containing an inactive gas and an oxygen gas by the use of Ta and Hf as a target, respectively.

The film (silicon oxide film) made of a material containing silicon and oxygen is formed by sputtering or reactive sputtering in an inactive gas atmosphere or in a mixed gas atmosphere containing an inactive gas and an oxygen gas by the use of a target made of a material containing silicon (for example, containing at least one selected from Si, SiC, and SiO₂). The film made of a material containing silicon and oxygen is preferably formed by reactive sputtering in a mixed gas atmosphere containing an inactive gas and an oxygen gas by the use of a target made of a material containing silicon (containing at least one selected from SiC and SiO₂). This is because shortage of oxygen contained in the silicon oxide film is prevented.

As a sputtering method, direct current (DC) sputtering or radio frequency (RF) sputtering is available. In order to obtain a film uniform and excellent in quality and, in particular, in order to meet a defect quality (without any defect (foreign matters and pinholes) of 10 μm or more) required for the liquid crystal projector of a projection type, the direct current (DC) sputtering is preferable. As a target to be sputtered by the direct current (DC) sputtering, a Si—Sn target made of silicon and tin is preferably used in order to deposit the oxide film containing silicon, tin, and oxygen. In order to deposit the titanium oxide film, the niobium oxide film, the tantalum oxide film, and the hafnium oxide film, a target of TiO₂ or TiO₂₋ₓ, a target of Nb₂O₅ or Nb₂O₅₋ₓ, a target of Ta, a target of Hf are preferably used, respectively. In order to deposit the silicon oxide film, a SiC (silicon carbide) target or a Si—SiC target is preferably used.

The oxygen gas is not only a pure oxygen gas but also may contain an additional component as far as the refractive index in each film falls within the above-mentioned range. As the additional component, nitrogen or carbon may be used. In this case, an acidic gas, such as an NO gas (nitrogen oxide), N₂O (nitrous oxide), NO₂ (nitrogen dioxide), or CO₂ (carbon dioxide) may be used.

Each of the above-mentioned layers (the medium refractive index layer, the high refractive index layer, the low refractive index layer) is preferably deposited by the use of a plurality of targets. (Structure 3)

In this event, not only the throughput is increased and the productivity is improved but also the sputtering power upon deposition using each target is suppressed. Furthermore, the amount of the oxygen gas upon deposition of the oxide film is reduced. Therefore, it is possible to prevent occurrence of a defect, such as particles, due to arcing.

The above-mentioned antireflection film is a multilayer film in which the medium refractive index layer has a refractive index between 1.6 and 1.8 and a geometrical thickness between 60 nm and 90 nm, the high refractive index layer has a refractive index between 2.1 and 2.8 and a geometrical thickness between 90 nm and 130 nm, and the low refractive index layer has a refractive index between 1.4 and 1.46 and a geometrical thickness between 80 nm and 100 nm. (Structure 4)

With the above-mentioned film structure, it is possible to satisfy the desired optical characteristic required for an antireflection-coated substrate for use as a dust-proof substrate for a liquid crystal panel or a cover glass for a solid-state image pickup device. Specifically, in case of the dust-proof substrate for a liquid crystal panel, it is possible to achieve a low reflectance of 0.5% or less (single-surface reflectance on one surface on the side of the antireflection film) in a visible range (430 nm to 630 nm). In case of the cover glass for a solid-state image pickup device, it is possible to achieve a low reflectance of 1% or less (double-surface by the antireflection film and the glass substrate) in a visible range (430 nm to 630 nm).

Specifically, the medium refractive index layer, the high refractive index layer, and the low refractive index layer are made of the following materials. The medium refractive index layer is made of a material (SiₓSn_{y}O_{z}) containing silicon, tin, and oxygen. The high refractive index layer is made of a material selected from a group consisting of a material (TiO₂) containing titanium and oxygen, a material (Nb₂O₅) containing niobium and oxygen, a material (Ta₂O₅) containing tantalum and oxygen, and a material (HfO₂) containing hafnium and oxygen. The low refractive index layer is made of a material (SiO₂) containing silicon and oxygen. (Structure 5)

In this invention, the transparent substrate is made of a material having a high transmittance in a frequency range over which it is used. Since the liquid crystal panel and the solid-state image pickup device are used in a visible range, a glass is generally used as the material of the transparent substrate. The glass preferably has a refractive index of 1.46 to 1.53 in order to satisfy desired optical characteristics required for the dust-proof substrate for a liquid crystal panel and the cover glass for a solid-state image pickup device. (Structure 6) For example, a quartz glass, glass ceramics, an alkali-free glass, and so on may be used in the dust-proof substrate for a liquid crystal panel. On the other hand, glass ceramics, an alkali-free glass, a borosilicate glass, a near-infrared absorbing glass, and so on may be used in the cover glass for a solid-state image pickup device.

Consideration will be made of the dust-proof substrate for a liquid crystal panel. Generally, a quartz glass is used as an opposite substrate of the liquid crystal panel. In this case, the dust-proof substrate is preferably made of a quartz glass which is a material same as that of the opposite substrate, or glass ceramics having a small coefficient of thermal expansion. As such a glass ceramics having an average coefficient of thermal expansion between −5×10⁻⁷/° C. and +5×10⁻⁷/° C., glass ceramics having a crystal phase containing p-quartz solid solution is available. For example, the glass ceramics is obtained by preparing a glass ceramics raw material glass having a glass composition of 55-70 mol % SiO₂, 13-23 mol % Al₂O₃, 11-21 mol % alkali metal oxides (where the content of Li₂O is 10-20 mol % and the total content of Na₂O+K₂0 is 0.1-3 mol %), 0.14 mol % TiO₂, 0.1-2 mol % ZrO₂, the total content of SiO₂, Al₂O₃, alkali metal oxides, TiO₂, and ZrO₂ being 95 mol % or more, 0-0.2 (where 0.2 is exclusive) mol % BaO, 0-0.1 (where 0.1 is exclusive) mol % P₂O₅, 0-0.3 (where 0.3 is exclusive) mol % B₂O₃, and 0-0.1 (where 0.1 is exclusive) mol % SnO₂, and heat-treating the raw material glass to precipitate or deposit a crystal phase containing p-quartz solid solution.

Consideration will be made of the cover glass for a solid-state image pickup device. In order to prevent soft error caused by α-ray emitted from the cover glass, use is preferably made of a glass material containing a reduced amount of radioisotope such as U (uranium) and Th (thorium). Specifically, a borosilicate glass in which the content of each of U and Th is less than 5 ppb is preferable. For example, the borosilicate glass has a glass composition of 50-78 mol % SiO₂, 5-25 mol % B₂O₃, 0-8 mol % Al₂O₃, 0-5 mol % Li₂O, 0-18 mol % Na₂O, 0-20 mol % K₂0 (where the total content of Li₂O+Na₂O+K₂0 is 5-20 mol %), the total content of SiO₂, B₂O₃, Al₂O₃, Li₂O, Na₂O, and K₂0 being 80 mol % or more.

An antireflection-coated surface of the glass substrate on which the antireflection film is formed has a surface roughness of 0.5 nm or less as a center-line-mean roughness Ra. (Structure 7) The center-line-mean roughness Ra is defined in Japanese Industrial Standard JIS B0601 and is disclosed in, for example, U.S. Pat. No. 6,544,893B2. This further improves the above-mentioned optical characteristics (the reflectance and the transmittance).

As compared with the above-mentioned oxides, the material (SiₓSn_{y}O_{z}) containing silicon, tin, and oxygen deposited on the surface of the glass substrate is greater in deposition rate upon sputtering. Therefore, the surface roughness of a resultant film (SiₓSn_{y}O_{z}) tends to be large. If the surface of the glass substrate has a large surface roughness (the center-line-mean roughness Ra exceeding 0.5 nm), the oxide film of the material (SiₓSn_{y}O_{z}) containing silicon, tin, and oxygen is increased in surface roughness. As a result, the surface roughness of the antireflection film is increased so that the optical characteristics are degraded.

By precision-polishing the glass substrate by the use of a polisher, such as cerium oxide, zirconium oxide, and colloidal silica, having an average particle size not greater than 1 μm, the center-line-mean roughness Ra can be suppressed to 0.5 nm or less.

The center-line-mean roughness Ra of the glass substrate is preferably 0.3 nm or less, more preferably 0.15 nm or less.

By forming a transparent conductive film between the high refractive index layer and the low refractive index layer (Structure 8), a conductive antireflection-coated substrate is obtained. As the transparent conductive film, use may be made of indium tin oxide (ITO) (having a refractive index of 2.05) and indium cerium oxide (having a refractive index of 2.05-2.30 (variable depending upon the content of cerium oxide)). The transparent conductive film may be formed by sputtering by the use of In₂O₃—SnO₂ or In₂O₃—CeO₂ as a target.

### EXAMPLES

### Example 1

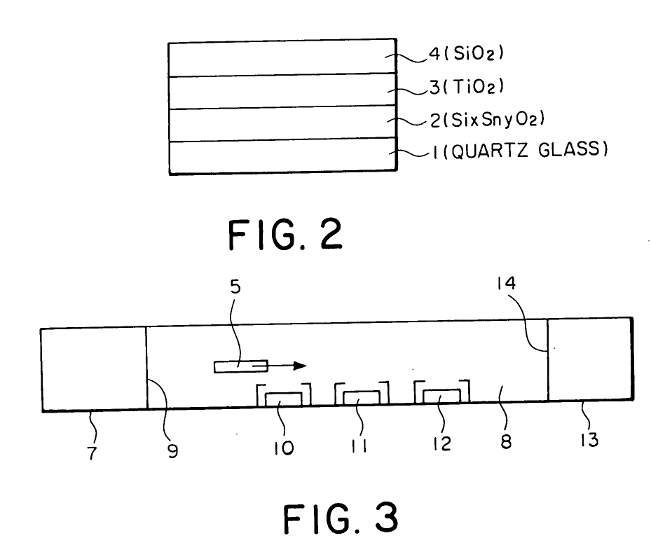

Referring to FIGS. 2 and 3, description will be made of a dust-proof substrate for a liquid crystal panel and a method of producing the same according to this invention.

Referring to FIG. 2, the dust-proof substrate for a liquid crystal panel comprises a transparent substrate 1 of a quartz glass (having a refractive index (n) of 1.46) precision-polished to the center-line-mean roughness (Ra) of 0.5 nm or less which is measured by an inter-atomic force microscope (AFM). On the transparent substrate 1, a medium refractive index layer 2 (SiₓSn_{y}O_{z}) made of a material containing silicon, tin, and oxygen, a high refractive index layer 3 (TiO₂) of titanium oxide, and a low refractive index layer 4 (SiO₂) of silicon oxide are successively laminated. The medium refractive index layer 2 has the refractive index (nₘ) of 1.7 and the thickness (dₘ) of 77 nm. The high refractive index layer 3 has the refractive index (nₕ) of 2.4 and the thickness (dₕ) of 110 nm. The low refractive index layer 4 has the refractive index (nᵢ) of 1.46 and the thickness (dₗ) of 90 nm.

Next referring to FIG. 3, the method of producing the dust-proof substrate in this example will be described. Preparation was made of a quartz glass substrate 1 preliminarily subjected to grinding and polishing and having the size of 200 mm×200 mm, the thickness of 1.1 mm, and the center-line-mean roughness (Ra) of 0.5 nm or less which is measured by an inter-atomic force microscope (AFM). The quartz glass substrate 1 was mounted on a substrate holder or pallet 5. The pallet 5 was introduced into a loading chamber 7 of an in-line DC magnetron sputtering apparatus 6 illustrated in FIG. 3. Thereafter, the loading chamber 7 was evacuated from an atmospheric pressure to a high vacuum equivalent to that of a sputtering chamber or vacuum chamber 8. Then, a partitioning plate 9 was opened to introduce the pallet 5 into the vacuum chamber 8. The pallet 5 was moved at a predetermined transfer speed to pass a medium refractive index layer target 10, a high refractive index layer target 11, and a low refractive index layer target 12 successively disposed in a transfer direction of the pallet 5. The medium refractive index layer target 10 was made of Si—Sn (50 at % Si and 50 at % Sn). The high refractive index layer target 11 was made of TiO₂₋ₓ. The low refractive index layer target 12 was made of Si—SiC. These targets were disposed in the above-mentioned order in the transfer direction of the pallet 5. In accordance with the order of the targets disposed as mentioned above, the medium refractive index layer (SiₓSn_{y}O_{z}, having the refractive index of 1.7 and the thickness of 77 nm) 2, the high refractive index layer (TiO₂, having the refractive index of 2.4 and the thickness of 110 nm) 3, and the low refractive index layer (SiO₂, having the refractive index of 1.46 and the thickness of 90 nm) 4 were successively laminated in this order. Next, a partitioning plate 14 between the vacuum chamber 8 and an unloading chamber 13 was opened to transfer the pallet 5 into the unloading chamber 13 preliminarily evacuated to a high vacuum substantially equivalent to that of the vacuum chamber 8. Deposition of these layers was carried out in the vacuum chamber 8 kept in a mixed gas atmosphere containing an argon gas and an oxygen gas.

In the above-mentioned manner, an antireflection-coated substrate was obtained which comprises the quartz glass substrate 1 with the medium refractive index layer 2, the high refractive index layer 3, and the low refractive index layer 4 formed thereon as the antireflection film.

Next, the antireflection-coated substrate was cut into the size of 25 mm×18 mm to obtain the dust-proof substrate for a liquid crystal panel in this example.

For the dust-proof substrate thus obtained, measurement was made of the transmittance and the reflectance in a visible range (430-650 nm). As a result, the transmittance was 96% or more (the transmittance by the antireflection film and the glass substrate) (the transmittance on the antireflection-coated surface with the antireflection film being 99.6% or more). The reflectance was 0.4% or less (the single-surface reflectance on the side of the antireflection-coated surface with the antireflection film). Thus, the optical characteristics were excellent. Foreign matters or pinholes having a size of 10 μm or more were not found in the antireflection film.

In order to evaluate the film adhesion, the dust-proof substrate thus obtained was subjected to a pressure cooker test (the substrate was left in an environment of 1.2 atm and 120° C. for 1000 hours). As a result, no film peeling was observed after the pressure cooker test. This is presumably because the antireflection film was formed without an unnecessary oxide film formed between the respective layers of the antireflection film.

### REFERENCE EXAMPLE

Three sputtering apparatuses of an opposed target static deposition type were provided. A medium refractive index layer target (Si—Sn (50 at % Si and 50 at % Sn)), a high refractive index layer target (TiO₂₋ₓ), and a low refractive index layer target 12 (SiO₂) were placed in these sputtering apparatuses, respectively. On a quartz glass substrate, a medium refractive index layer (SiₓSn_{y}O_{z}, having the refractive index of 1.7 and the thickness of 77 nm), a high refractive index layer (TiO₂, having the refractive index of 2.4 and the thickness of 110 nm), and a low refractive index layer (SiO₂, having the refractive index of 1.46 and the thickness of 90 nm) were successively deposited in this order. Deposition was carried out in a vacuum chamber kept in a mixed gas atmosphere containing an argon gas and an oxygen gas. The medium refractive index layer and the high refractive index layer were sputtered by direct current (DC) sputtering while the low refractive index layer was sputtered by radio frequency (RF) sputtering. The quartz glass substrate was transferred in atmospheric air when the quartz glass substrate was delivered among these sputtering apparatuses.

For the dust-proof substrate thus obtained, measurement was made of the transmittance and the reflectance in a visible range (430-650 nm). As a result, the transmittance was 95% or more (the transmittance by the antireflection film and the glass substrate, the transmittance on the antireflection-coated surface with the antireflection film being 99.5% or more). The reflectance was 0.5% or less (the single-surface reflectance on the side of the antireflection-coated surface with the antireflection film). Thus, the optical characteristics were excellent. Foreign matters or pinholes having a size of 10 μm or more were not found in the antireflection film.

The dust-proof substrate thus obtained was subjected to a pressure cooker test (the substrate was left in an environment of 1.2 atm and 120° C. for 1000 hours). As a result, film peeling was observed in some samples after the pressure cooker test. This is presumably because the substrate was taken out into atmospheric air when it is transferred from one apparatus to another during deposition of the respective layers of the antireflection film and, as a result, an unnecessary oxide film was formed between the respective layers.

From the above-mentioned results, it is understood that the antireflection film is preferably formed by successive deposition using an in-line sputtering apparatus in order to improve the film adhesion of the antireflection film.

### Examples 2 and 3

Dust-proof substrates for a liquid crystal panel were prepared in the manner similar to Example 1 except that the high refractive index layer target 11 was made of Nb₂O₅₋ₓ (Example 2) or Ta (Example 3) and that the ratio of Si and Sn in the material of the medium refractive index layer target 10 was appropriately changed in correspondence to the refractive index of the high refractive index layer to be formed. The dust-proof substrate in Example 2 had a film structure of quartz glass/medium refractive index layer (SiₓSn_{y}O_{z}, having the refractive index of 1.69 and the thickness of 77 nm)/high refractive index layer (Nb₂O₅, having the refractive index of 2.35 and the thickness of 111 nm)/low refractive index layer (SiO₂, having the refractive index of 1.46 and the thickness of 89 nm). The dust-proof substrate in Example 3 had a film structure of quartz glass/medium refractive index layer (SiₓSn_{y}O_{z}, having the refractive index of 1.65 and the thickness of 79 nm)/high refractive index layer (Ta₂O₅, having the refractive index of 2.15 and the thickness of 121 nm)/low refractive index layer (SiO₂, having the refractive index of 1.46 and the thickness of 89 nm).

For the dust-proof substrates thus obtained, measurement was made of the transmittance and the reflectance in a visible range (430-650 nm). As a result, the transmittance was 96% or more (the transmittance by the antireflection film and the glass substrate) (the transmittance on the antireflection-coated surface with the antireflection film being 99.6% or more). The reflectance was 0.4% or less (the single-surface reflectance on the side of the antireflection-coated surface with the antireflection film). Thus, the optical characteristics were excellent. Foreign matters or pinholes having a size of 10 μm or more were not found in the antireflection film.

In order to evaluate the film adhesion, the dust-proof substrate thus obtained was subjected to a pressure cooker test (the substrate was left in an environment of 1.2 atm and 120° C. for 1000 hours). As a result, no film peeling was observed after the pressure cooker test. This is presumably because the antireflection film was formed without an unnecessary oxide film formed between the respective layers of the antireflection film.

### Example 4

A dust-proof substrate for a liquid crystal panel was produced in the manner similar to Example 2 except that two targets were used for each of the medium refractive index layer target, the high refractive index layer target, and the low refractive index layer target. In this case, the antireflection film could be deposited under a depositing condition in which the sputtering power is half and the oxygen concentration is reduced by 2-10% as compared with Example 2.

As a result, in the dust-proof substrate thus obtained, the transmittance and the reflectance in a visible range (430-650 nm) were similar to those in Example 2. Thus, the optical characteristics were excellent. Foreign matters or pinholes having a size of 10 μm or more were not found in the antireflection film. The film adhesion was evaluated in a similar test. As a result, no film peeling was observed.

For Examples 2 and 4, examination was made of the number of defects smaller than 10 μm (between about 1 μm and 10 μm). In Example 4, the number of defects was reduced to become equal to 25% of that of Example 2.

### Comparative Example 1

A dust-proof substrate for a liquid crystal panel was produced in the manner similar to Example 1 except that the antireflection film is formed by successively depositing an aluminum oxide film (Al₂O₃), a zirconium oxide film (ZrO₂), and a magnesium fluoride film (MgF₂) on a quartz glass substrate in this order by vacuum deposition. The aluminum oxide film, the zirconium oxide film, and the magnesium oxide film had a film thickness of 83 nm, 132 nm, and 98 nm, respectively.

The antireflection film of the dust-proof substrate thus obtained was observed. As a result, a number of foreign matters and pinholes having a size of 10 μm or more, inherent to the vapor deposition, were confirmed in the antireflection film. Measurement was made of the transmittance and the reflectance in a visible range (430-650 nm). As a result, in some samples, the transmittance was about 94% (the transmittance by the antireflection film and the glass substrate) (the transmittance on the antireflection-coated surface with the antireflection film being about 99.4%) and the reflectance was about 0.6% (the single-surface reflectance on the side of the antireflection-coated surface with the antireflection film). Thus, some samples did not satisfy the optical characteristics for the dust-proof substrate for a liquid crystal panel.

The dust-proof substrate thus obtained was subjected to a pressure cooker test (the substrate was left in an environment of 1.2 atm and 120° C. for 1000 hours). As a result, film peeling was observed in some samples after the pressure cooker test.

Production of Liquid Crystal Panel for Projection-Type

Liquid Crystal Projector

Hereinafter, description will be made of production of a liquid crystal panel for a projection-type liquid crystal projector by combining the dust-proof substrate prepared in each of the foregoing examples and an opposite substrate for a liquid crystal panel separately prepared.

Generally, a liquid crystal panel for use in a liquid crystal display comprises a liquid crystal layer interposed between a drive substrate and an opposite substrate arranged opposite to each other for holding and driving the liquid crystal layer. The drive substrate comprises a base substrate, a plurality of pixel electrodes formed on the base substrate, and a switching device connected to the pixel electrode. On the other hand, the opposite substrate comprises a light transmitting substrate and a plurality of opposite electrodes formed on the light transmitting substrate at a position opposite to the pixel electrode. The liquid crystal layer is held between the drive substrate and the opposite substrate via orientation films and is driven by an electric voltage applied between the pixel electrode and the opposite electrode.

Depending upon the orientation of the liquid crystal layer controlled by the pixel electrode and the opposite electrode, a light beam incident to the liquid crystal panel on the side of the opposite substrate is controlled in transmittance for each pixel to form a predetermined pixel. Furthermore, in the above-mentioned liquid crystal panel, a light transmitting substrate having a predetermined thickness as a dust-proof substrate may be bonded to an outer surface of at least one of the drive substrate and the opposite substrate for the purpose of heat release and in order to prevent deterioration in picture quality caused by a dust or the like adhered to the liquid crystal panel.

In this example of production of the liquid crystal panel, the dust-proof substrate prepared in each of the foregoing examples was bonded to the outer surface of each of the drive substrate and the opposite substrate.

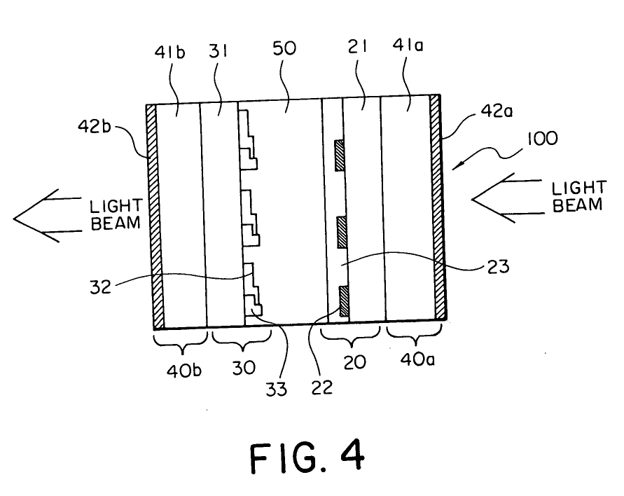

Referring to FIG. 4, a liquid crystal panel 100 with a dust-proof substrate comprises an opposite substrate 20, a drive substrate 30, and dust-proof substrates 40a and 40b bonded to outer surfaces of the opposite substrate 20 and the drive substrate 30, respectively.

At first, the opposite substrate 20 will be described.

The opposite substrate 20 comprises a light transmitting substrate 21 and an opposite electrode 23 formed thereon. If necessary, a light shielding layer 22 is formed on the light transmitting substrate 21 in a matrix fashion at positions opposite to switching devices 33 of the drive substrate 30 in order to prevent an incident light beam from being incident to the switching devices 33.

The light shielding layer 22 is generally made of a material capable of shielding the incident light beam. Preferably, the light shielding layer 22 has a high reflectance film on a light incident side in order to prevent malfunction of the liquid crystal panel due to heat absorbed by the light shielding layer. Furthermore, the light shielding layer preferably has a low reflectance film on a drive substrate side in order to prevent stray light in the liquid crystal layer. More preferably, the light shielding layer 22 comprises a multilayer film composed of a high reflectance film and a low reflectance film formed on the light incident side and on the drive substrate side, respectively. The light shielding layer 22 may be formed on the light transmitting substrate 21 by the photolithography or the like known in the art.

The opposite electrode 23 on the light transmitting substrate 21 controls the orientation of the liquid crystal layer 50, in cooperation with a plurality of pixel electrodes 32 on the drive substrate 30. The opposite electrode 23 is made of a material transparent to the incident light beam and having conductivity, for example, a transparent conductive film. As a material transparent to a visible light beam and having conductivity, an ITO film is available. The transparent conductive film may be formed by a known technique.

In order to effectively introduce the incident light beam into a pixel region, the opposite substrate 20 may be provided with a microlens array formed on a light incident surface thereof. In this event, the opposite substrate with the microlens array is bonded to the dust-proof substrate by the use of an adhesive (thermosetting resin or the like).

In necessary, the opposite substrate may be provided with a color filter. In this event, color display can be carried out.

Next, the dust-proof substrates 40a and 40b will be described.

The dust-proof substrates 40a and 40b are bonded to the outer surfaces of the opposite substrate 20 and the drive substrate 30, respectively, for the purpose of heat release and in order to prevent deterioration in picture quality due to a dust adhered to the opposite substrate 20 or the drive substrate 30. The dust-proof substrates 40a and 40b comprise transparent substrates 41a and 41b and antireflection films 42a and 42b formed thereon, respectively. As described in conjunction with Examples 1 to 4, the antireflection film 42a or 42b is formed by successively laminating the medium refractive index layer (SiₓSn_{y}O_{z}), one of the high refractive index layer (TiO₂) made of titanium oxide, the high refractive index layer (Nb₂O₅) made of niobium oxide, and the high refractive index layer (Ta₂O₅) made of tantalum oxide, and the low refractive index layer (SiO₂) made of silicon oxide on the transparent substrate 41a or 41b.

Instead of the dust-proof substrate 40a and 40b, a single dust-proof substrate may be formed on the outer surface of one of the opposite substrate 20 and the drive substrate 30.

In order to prevent the incidence of light to a wiring for driving the switching device 33 of the drive substrate 30, a light shielding film having a predetermined width may be formed on an outer periphery of the dust-proof substrate.

The dust-proof substrate for a liquid crystal panel in this invention may be used for a reflective liquid crystal panel, such as a reflective projector.

In Examples 1-4 described above, the quartz glass substrate was used as the transparent substrate for the dust-proof substrate. However, as the transparent substrates 41a and 41b illustrated in FIG. 4, glass ceramics excellent in various characteristics may be used instead of the quartz glass substrate.

As the glass ceramics, glass ceramics having a crystal phase containing β-quartz solid solution is available. For example, the glass ceramics may be obtained by preparing a glass ceramics raw material glass having a glass composition of 55-70 mol % SiO₂, 13-23 mol % Al₂O₃, 11-21 mol % alkali metal oxides (where the content of Li₂O is 10-20 mol % and the total content of Na₂O+K₂0 is 0.1-3 mol %), 0.1-4 mol % TiO₂, 0.1-2 mol % ZrO₂, the total content of SiO₂, Al₂O₃, alkali metal oxides, TiO₂, and ZrO₂ being 95 mol % or more, 0-0.2 (where 0.2 is exclusive) mol % BaO, 0-0.1 (where 0.1 is exclusive) mol % P₂O₅, 0-0.3 (where 0.3 is exclusive) mol % B₂O₃, and 0-0.1 (where 0.1 is exclusive) mol % SnO₂, and heat-treating the raw material glass to precipitate or deposit a crystal phase containing β-quartz solid solution.

The above-mentioned glass ceramics has a high spectral transmittance (transparency) in a visible light range, a low thermal expansion characteristic, a small specific gravity (not smaller than 2.2 and smaller than 2.5), and a light weight. Therefore, the glass ceramics can be used instead of the quartz glass which is expensive. Specifically, the spectral transmittance (transparency) is 70% or more per the thickness of 5 mm in a range of 400-750 nm and/or 85% or more per the thickness of 1.1 mm in a range of 400-750 nm. Since the coefficient of thermal expansion is small (specifically, the average coefficient of thermal expansion is between −5×10⁻⁷/° C. and +5×10⁻⁷/° C.), heat shock resistance is superior. The light weight is advantageous for reduction in weight of the liquid crystal panel. In addition, the productivity of the glass ceramics itself is good so that the low cost is achieved. Thus, the glass ceramics is advantageously used as a material of the dust-proof substrate for a liquid crystal panel. As compared with other glass ceramics substrates, the above-mentioned glass ceramics substrate has an excellent transmittance at around 365 nm which is useful for ultraviolet setting and, therefore, can be bonded by the use of an ultraviolet setting resin.

A raw material glass for the above-mentioned glass ceramics has a relatively low melting temperature. Therefore, by the use of a melting furnace for a typical optical glass, the raw material glass extremely excellent in uniformity or homogeneity can be obtained. In addition to the composition hardly colored, impurities causing coloration are hardly released from a container or a refractory to be mixed during melting of the raw material glass. Thus, the glass ceramics having a high spectral transmittance in a visible light range, a low thermal expansion characteristic, and a low specific gravity can be produced by crystallization in a relatively short time.

The above-mentioned glass ceramics substrate may advantageously used as the opposite substrate 20 in the liquid crystal panel described in conjunction with FIG. 4.

### Example 5

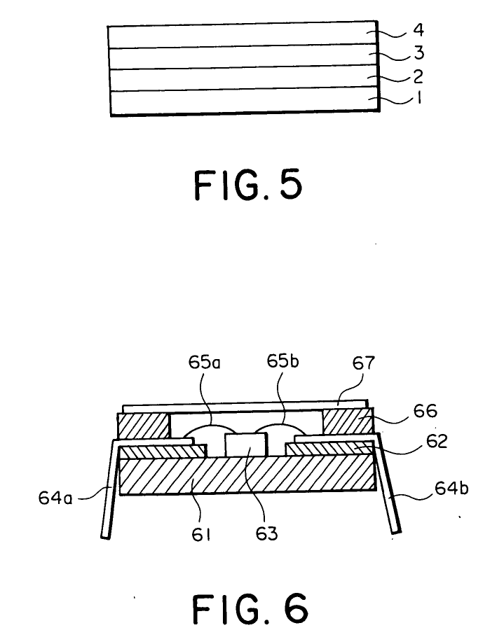

Referring to FIGS. 5 and 3, description will be made of the cover glass for a solid-state image pickup device and the method of producing the same according to this invention.

Referring to FIG. 5, the cover glass for a solid-state image pickup device comprises a transparent substrate 1 of a borosilicate glass (having a refractive index (n) of 1.51) precision-polished to the center-line-mean roughness (Ra) of 0.5 nm or less which is measured by an inter-atomic force microscope (AFM). On the transparent substrate 1, a medium refractive index layer 2 (SiₓSn_{y}O_{z}) made of a material containing silicon, tin, and oxygen, a high refractive index layer 3 (Nb₂O₅) of niobium oxide, and a low refractive index layer 4 (SiO₂) of silicon oxide are successively laminated. The medium refractive index layer 2 has the refractive index (nₘ) of 1.7 and the thickness (dₘ) of 76 nm. The high refractive index layer 3 has the refractive index (nₕ) of 2.35 and the thickness (dₕ) of 111 nm. The low refractive index layer 4 has the refractive index (nₗ) of 1.46 and the thickness (dₗ) of 89 nm.

Turning back to FIG. 3, the method of producing the cover glass in this example will be described. Preparation was made of the transparent substrate 1 preliminarily subjected to grinding and polishing and having the size of 90 mm×90 mm, the-thickness of 0.5 mm, and the center-line-mean roughness (Ra) of 0.5 nm or less which is measured by an inter-atomic force microscope (AFM). The transparent substrate 1 was mounted on the substrate holder or pallet 5. The pallet 5 was introduced into the loading chamber 7 of the in-line DC magnetron sputtering apparatus 6 illustrated in FIG. 3. Thereafter, the loading chamber 7 was evacuated from an atmospheric pressure to a high vacuum equivalent to that of the sputtering chamber or vacuum chamber 8. Then, the partitioning plate 9 was opened to introduce the pallet 5 into the vacuum chamber 8. The pallet 5 was moved at a predetermined transfer speed to pass the medium refractive index layer target 10, the high refractive index layer target 11, and the low refractive index layer target 12 successively disposed in the transfer direction of the pallet 5. The medium refractive index layer target 10 was made of Si—Sn (50 at % Si and 50 at % Sn). The high refractive index layer target 11 was made of Nb₂O₅₋ₓ. The low refractive index layer target 12 was made of Si—SiC. These targets were disposed in the above-mentioned order in the transfer direction of the pallet 5. In accordance with the order of the targets disposed as mentioned above, the medium refractive index layer (SiₓSn_{y}O_{z}, having the refractive index of 1.7 and the thickness of 77 nm) 2, the high refractive index layer (Nb₂O₅, having the refractive index of 2.35 and the thickness of 111 nm) 3, and the low refractive index layer (SiO₂, having the refractive index of 1.46 and the thickness of 89 nm) 4 were successively laminated in this order. Next, the partitioning plate 14 between the vacuum chamber 8 and the unloading chamber 13 was opened to transfer the pallet 5 into the unloading chamber 13 preliminarily evacuated to a high vacuum substantially equivalent to that of the vacuum chamber 8. Deposition of these layers was carried out in the vacuum chamber 8 kept in a mixed gas atmosphere containing an argon gas and an oxygen gas.

In the above-mentioned manner, an antireflection-coated transparent substrate was obtained which comprises the transparent substrate 1 with the medium refractive index layer 2, the high refractive index layer 3, and the low refractive index layer 4 formed thereon as an antireflection film.

Next, the antireflection-coated transparent substrate was cut into the size of 6.5 mm×5.6 mm to obtain the cover glass for a solid-state image pickup device in this example.

For the cover glass thus obtained, measurement was made of the transmittance and the reflectance in a visible range (430-650 nm). As a result, the transmittance was 99% or more (the transmittance by the antireflection film and the glass substrate). A sum of the reflectance on the antireflection film and the reflectance on the surface of the glass substrate was 1%. Thus, the optical characteristics were excellent. Foreign matters or pinholes were not found.

In order to evaluate the film adhesion, the cover glass thus obtained was subjected to a pressure cooker test (the substrate was left in an environment of 1.2 atm and 120° C. for 1000 hours). As a result, no film peeling was observed after the pressure cooker test. This is presumably because the antireflection film was formed without an unnecessary oxide film formed between the respective layers of the antireflection film.

Solid-State Image Pickup Device with Cover Glass

Hereinafter, description will be made of a solid-state image pickup device with the above-mentioned cover glass in this example.

Referring to FIG. 6, the solid-state image pickup device comprises a base plate 61 with a frame member 62 and a chip 63 mounted thereon. On the frame member 62, leads 64a and 64b, a frame member 66, and a cover glass 67 are successively bonded in this order. The leads 64a and 64b on both sides of the chip 63 are connected to electrode terminals of the chip 63 via bonding wires 65a and 65b, respectively.

The cover glass in this example is provided with the antireflection film and therefore has an effect of efficiently introducing light to a light receiving surface in addition to its original effect of protecting the chip.

### Example 6

Now, description will be made of the conductive antireflection-coated substrate. The conductive antireflection-coated substrate comprises a transparent substrate of a quartz glass (having a refractive index (n) of 1.46) precision-polished to the center-line-mean roughness (Ra) of 0.5 nm or less which is measured by an inter-atomic force microscope (AFM). On the transparent substrate, a medium refractive index layer (SiₓSn_{y}O_{z}) made of a material containing silicon, tin, and oxygen, a high refractive index layer (Nb₂O₅) of niobium oxide, a transparent conductive film (ITO) of indium tin oxide, and a low refractive index layer (SiO₂) of silicon oxide are successively laminated as an antireflection film. The medium refractive index layer has the refractive index (nₘ) of 1.7 and the thickness (dₘ) of 100 nm. The high refractive index layer has the refractive index (nₕ) of 2.35 and the thickness (dₕ) of 80 nm. The transparent conductive film has the refractive index (nₜ) of 2.1 and the thickness (dₜ) of 30 nm. The low refractive index layer has the refractive index (nₗ) of 1.46 and the thickness (dₗ) of 100 nm.

The conductive antireflection-coated substrate was produced in the following manner. In the in-line sputtering apparatus, a medium refractive index layer target of Si—Sn (50 at % Si and 50 at % Sn), a high refractive index layer target of Nb₂O₅₋ₓ, a transparent conductive film target of In₂O₃—SnO₂, and a low refractive index layer target of Si—SiC were disposed in the above-mentioned order in the transfer direction of the pallet. Deposition was carried out in a mixed gas atmosphere containing an argon gas and an oxygen gas.

For the conductive antireflection-coated substrate thus obtained, measurement was made of the reflectance in a visible range (430-650 nm). As a result, the reflectance was 0.6% or less (the single-surface reflectance on the side of the antireflection-coated surface with the antireflection film). Thus, the optical characteristic was excellent. Furthermore, the electric resistance was as excellent as 100-200 Ω/Inch².

Foreign matters or pinholes were not observed in the antireflection film. In evaluation of the film adhesion similar to that described above, no film peeling was observed.

The above-mentioned conductive antireflection-coated substrate can thereafter be cut into a predetermined size to be used as an antireflection-coated substrate for a measuring instrument or the like.

According to this invention, it is possible to provide a method of producing an antireflection-coated substrate which is excellent in film adhesion without causing film peeling even in a severe environment.

It is also possible to provide a method of producing an antireflection-coated substrate for use as a dust-proof substrate for a liquid crystal panel or a cover glass for a solid-state image pickup device, which is capable of satisfying desired optical characteristics required for the dust-proof substrate and the cover glass, in addition to the above-mentioned characteristic.

What is claimed is:

1. A method of producing an antireflection-coated substrate comprising a transparent substrate (1) and an antireflection film formed on the transparent substrate, the antireflection film comprising a multilayer film having a medium refractive index layer (2), a high refractive index layer (3), and a low refractive index layer (4) successively formed on the transparent substrate in this order, the medium refractive index layer being made of a material comprising silicon, tin, and oxygen, the high refractive index layer being made of a material comprising oxygen and at least one element selected from a group consisting of titanium, niobium, tantalum, and hafnium, the low refractive index layer being made of a material comprising silicon and oxygen, the antireflection film being formed by successively depositing these layers by an in-line sputtering apparatus.

2. A method according to claim 1, wherein the antireflection film is formed by sputtering or reactive sputtering in an inactive gas atmosphere or in a mixed gas atmosphere comprising an inactive gas and an oxygen gas, the medium refractive index layer being deposited by the use of target (10) made of a material comprising silicon and tin, the high refractive index layer being deposited by the use of a target (11) made of a material comprising one element selected from a group consisting of titanium, niobium, tantalum, and hafnium, the low refractive index layer being deposited by the use of a target (12) made of a material comprising silicon.

3. A method according to claim 2, wherein each of the medium refractive index layer, the high refractive index layer, and the low refractive index layer is deposited by the use of a plurality of targets.

4. A method according to claim 1, wherein the medium refractive index layer has a refractive index between 1.6 and 1.8 and a geometrical thickness between 60 nm and 90 nm, the high refractive index layer having a refractive index between 2.1 and 2.8 and a geometrical thickness between 90 nm and 130 nm, the low refractive index layer having a refractive index between 1.4 and 1.46 and a geometrical thickness between 80 nm and 100 nm.

5. A method according to claim 4, wherein the medium refractive index layer comprises SiₓSn_{y}O_{z}, the high refractive index layer comprising a material selected from a group consisting of TiO₂, Nb₂O₅, Ta₂O₅, and Hfb₂, the low refractive index layer comprising SiO₂.

6. A method according to claim 1, wherein the transparent substrate is a glass substrate having a refractive index between 1.46 and 1.53.

7. A method according to claim 6, wherein an antireflection-coated surface of the glass substrate on which the antireflection film is formed has a surface roughness of 0.5 nm or less as a center-line-mean roughness Ra.

8. A method according to claim 1, wherein a transparent conductive film is formed between the high refractive index layer and the low refractive index layer.

9. A method according to claim 1, wherein the antireflection-coated substrate is a dust-proof substrate for a liquid crystal panel.

10. A method according to claim 9, wherein the liquid crystal panel is a liquid crystal panel for a liquid crystal projector of a projection type.

11. A method according to claim 1, wherein the antireflection-coated substrate is a cover glass for a solid-state image pickup device.
